(19) United States
(12) Patent Application Publication
(10) Pub. No.: US 2014/0373010 A1
(43) Pub. Date: Dec. 18, 2014

(54) INTELLIGENT RESOURCE MANAGEMENT FOR VIRTUAL MACHINES

(71) Applicant: International Business Machines Corporation, Armonk, NY (US)

(72) Inventors: Rafael C.S. Folco, Santa Barbara d'Oeste (BR); Breno H. Leitao, Campinas (BR); Tiago N. dos Santos, Araraquara (BR)

(21) Appl. No.: 13/917,727

(22) Filed: Jun. 14, 2013

(51) Int. Cl. G06F 9/50; G06F 9/455

(52) U.S. Cl. CPC G06F 9/50; G06F 9/45533
USPC 718/1

(57) ABSTRACT

Embodiments of the present invention disclose a method, computer program product, and system for resource management for virtual machines. A computer receives information associated with one or more virtual machines, wherein the received information includes utilization information and workload information associated with each virtual machine of the one or more virtual machines. The computer analyzes the received information associated with the one or more virtual machines. The computer determines virtual machines for resource reallocation, wherein the determined virtual machines include one or more over-utilized virtual machines including at least one over-utilized resource. In another embodiment, the computer determines one or more under-utilized virtual machines, wherein the one or more under-utilized virtual machines include at least one under-utilized resource that corresponds to the determined one or more over-utilized resources. In another embodiment, the computer reallocates resources of the determined virtual machines for resource reallocation.

### FIELD OF THE INVENTION

The present invention relates generally to the field of resource management, and more particularly to resource management for virtual machines.

### BACKGROUND OF THE INVENTION

On a virtualized server, a number of virtual machines can exist. A virtual machine is a software implemented abstraction of underlying hardware (e.g., hardware of a virtualized server) that can be utilized to emulate functions of a physical computer (e.g., execute programs). Virtual machines can be implemented by adding a layer of software to a real machine (e.g., a server computer) to support the desired virtual machine architecture. A hypervisor, also known as a virtual machine monitor (VMM), is a piece of hardware, software, or firmware that is utilized to create and run virtual machines. Hypervisors manage resources available to virtual machines, and workloads associated with virtual machines.

A logical partition (LPAR) can be utilized to divide resources of a computer (e.g., memory, central processing units (CPUs), storage devices, and I/O devices) for utilization by virtual machines. The amount of predefined resources allocated to virtual machines (LPARs) can be reconfigured dynamically utilizing dynamic logical partitioning (DLPAR). The reconfiguration occurs without having to shut down the virtual machine running in the predefined LPAR. Within the same server, DLPAR allows memory, CPU capacity, and I/O interfaces to be moved between LPARs.

### SUMMARY

Embodiments of the present invention disclose a method, computer program product, and system for resource management for virtual machines. A computer receives information associated with one or more virtual machines, wherein the received information includes utilization information and workload information associated with each virtual machine of the one or more virtual machines. The computer analyzes the received information associated with the one or more virtual machines. The computer determines virtual machines for resource reallocation, wherein the determined virtual machines include one or more over-utilized virtual machines including at least one over-utilized resource. In another embodiment, the computer determines one or more under-utilized virtual machines, wherein the one or more under-utilized virtual machines include at least one under-utilized resource that corresponds to the determined one or more over-utilized resources of the identified one or more over-utilized virtual machines. In another embodiment, the computer reallocates resources of the determined virtual machines for resource reallocation.

### BRIEF DESCRIPTION OF THE SEVERAL VIEWS OF THE DRAWINGS

FIG. 1 is a functional block diagram of a data processing environment in accordance with an embodiment of the present invention.

FIG. 2 is an exemplary depiction of a server including virtual machines in accordance with an embodiment of the present invention.

FIG. 3 is a flowchart depicting operational steps of a program for managing resources allocated to virtual machines, in accordance with an embodiment of the present invention.

FIG. 4A is an exemplary depiction of an unbalanced virtual machine load in accordance with an embodiment of the present invention.

FIG. 4B is an exemplary depiction of a balanced virtual machine load in accordance with an embodiment of the present invention.

FIG. 5 depicts a block diagram of components of the computing system of FIG. 1 in accordance with an embodiment of the present invention.

### DETAILED DESCRIPTION

Exemplary embodiments of the present invention allow for management of virtual machine resources corresponding to resource utilization in order to optimize a virtualized server. In one embodiment, a workload profile and a utilization profile for one or more virtual machines are determined based on historical workload and utilization information. The workload profile and utilization profile are utilized to identify virtual machines with over-utilized resources. For virtual machines that are over-utilized, resources are reallocated from under-utilized virtual machines in order to achieve acceptable resource utilization.

Embodiments of the present invention recognize that on a virtualized server, a number of virtualized machines exist, where each virtual machine has a predefined amount of resources that can be adjusted (i.e. utilizing Dynamic Logical Partitioning DLPAR). The virtual machines experience varying workloads that lead to peaks in utilization, which can cause resources of a virtual machine to become over-utilized. DLPAR allows the predefined amount of resources allocated to a virtual machine to be modified while the virtual machine is operating.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

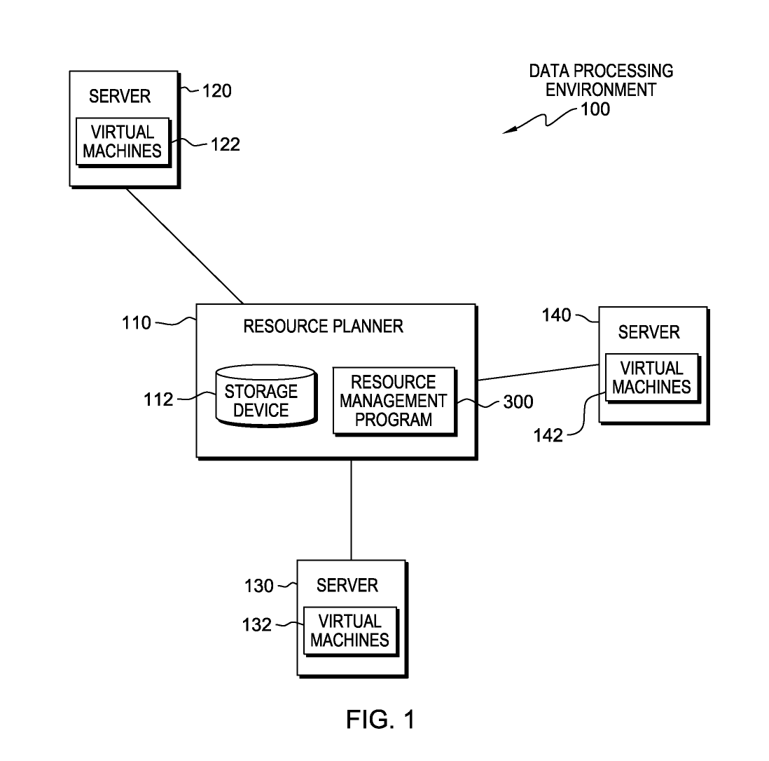

The present invention will now be described in detail with reference to the Figures. FIG. 1 is a functional block diagram illustrating data processing environment 100, in accordance with one embodiment of the present invention.

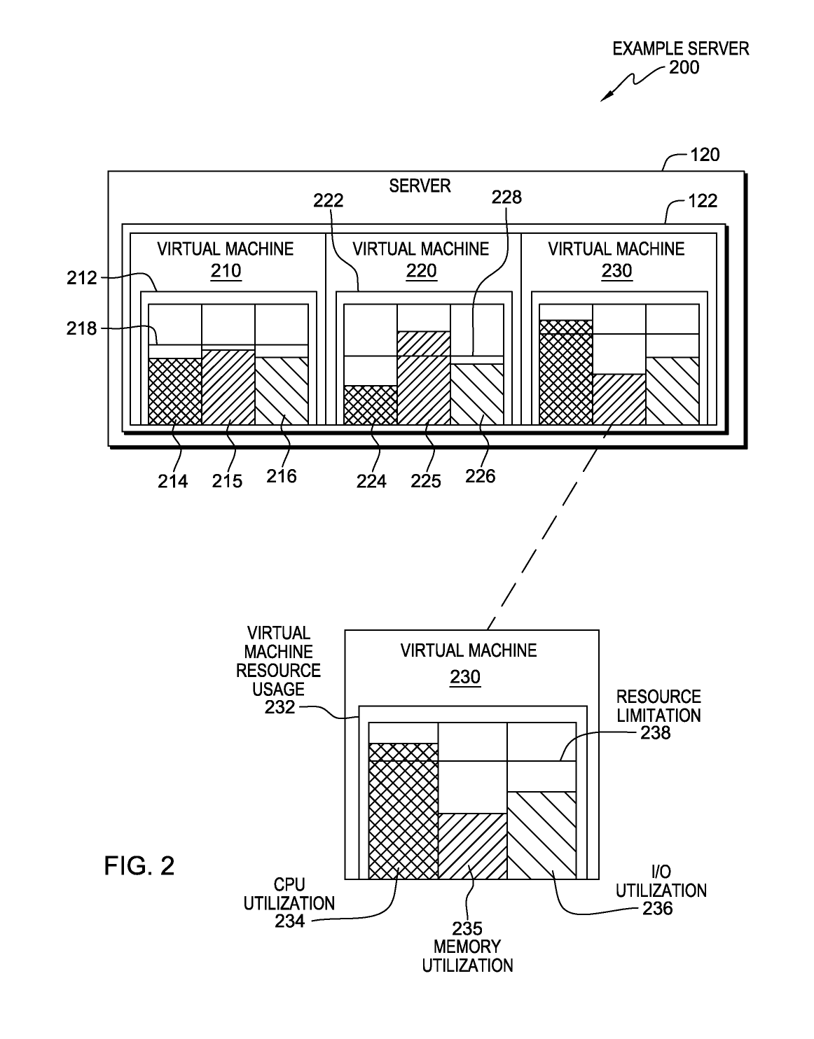

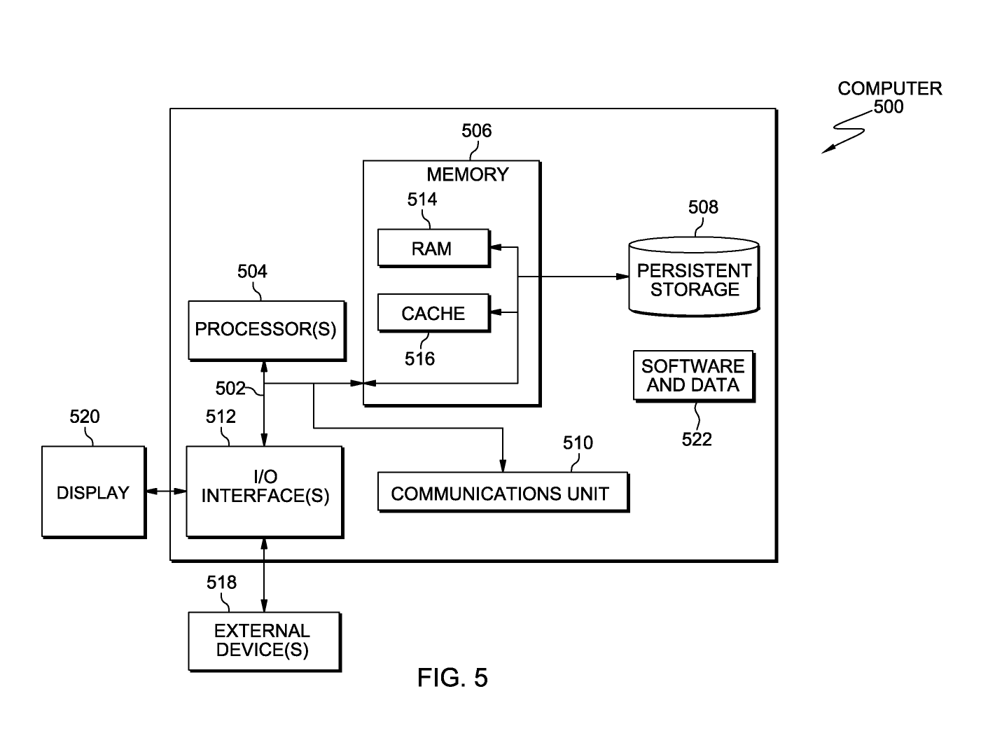

An exemplary embodiment of data processing environment 100 includes resource planner 110, and servers 120, 130 and 140. In one embodiment, resource planner receives data from servers 120, 130 and 140 corresponding to respective virtual machines 122, 132 and 142. Resource planner 110 utilizes data received from servers 120, 130 and 140 to monitor utilization of resources associated with virtual machines 122, 132 and 142. The data that resource planner receives and utilizes to monitor utilization is discussed in further detail with regard to FIG. 2. In another embodiment, resource planner 110 manages resource allocation of resources of servers 120, 130 and 140 to virtual machines 122, 132 and 142 (i.e. utilizing DLPAR). In exemplary embodiments, resource planner 110 can be a desktop computer, a computer server, or any other computer system known in the art. In certain embodiments, resource planner 110 represents a computer system utilizing clustered computers and components (e.g., database server computers, application server computers, etc.) that act as a single pool of seamless resources when accessed by elements of data processing environment 100. In general, resource planner 110 is representative of any electronic device or combination of electronic devices capable of executing machine-readable program instructions, as described in greater detail with regard to FIG. 5.

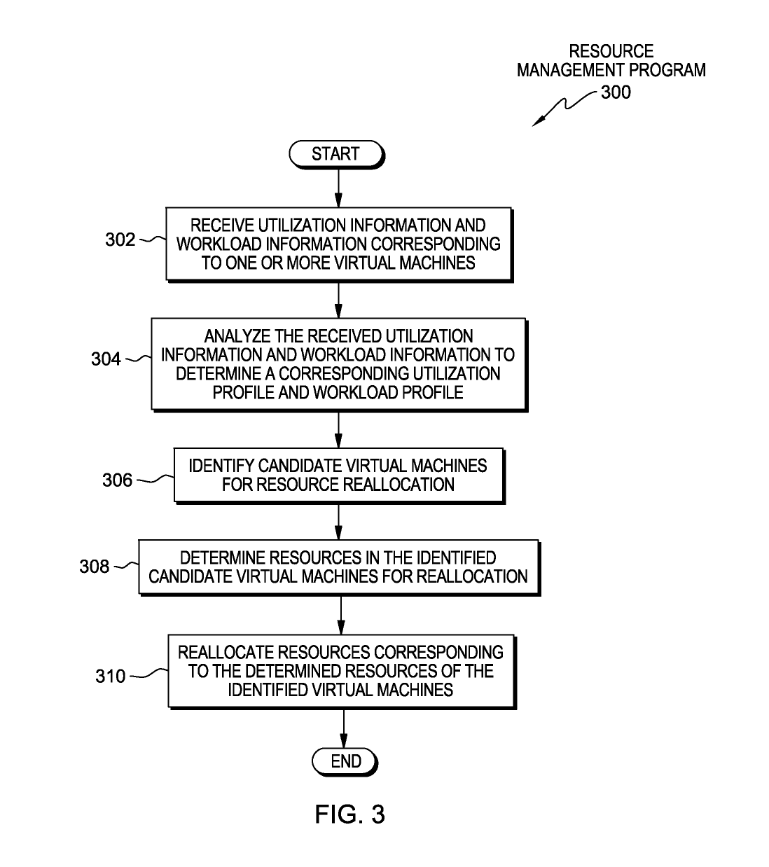

In an exemplary embodiment, resource planner 110 includes storage device 112 and resource management program 300. In one embodiment, storage device 112 stores data corresponding to utilization of resources, and workloads of virtual machines 122, 132 and 142. Resource planner 110 can access data in storage device 112 in order to determine a historical utilization and workload of resources corresponding to virtual machines 122, 132 and 142. Storage device 112 can be implemented with any type of storage device that is capable of storing data that may be accessed and utilized by resource planner 110, such as a database server, a hard disk drive, or flash memory. In other embodiments, storage device 112 can represent multiple storage devices within resource planner 110. In exemplary embodiments, resource management program 300 manages resources of virtual machines 122, 132 and 142 responsive to gathered historical information stored in storage device 112. Resource management program 300 is discussed in greater detail with regard to FIG. 3.

In one embodiment, a resource planner 110, and servers 120, 130 and 140 communicate through network communications. The network communications can be, for example, a local area network (LAN), a telecommunications network, a wide area network (WAN) such as the Internet, or a combination of the three, and include wired, wireless, or fiber optic connections. In general, the network communications can be any combination of connections and protocols that will support communications between resource planner 110, and servers 120, 130 and 140 in accordance with exemplary embodiments of the present invention.

In exemplary embodiments, servers 120, 130 and 140 include respective instances of virtual machines 122, 132 and 142. In one embodiment, servers 120, 130 and 140 are representations of virtualized servers that include some or more virtual machines (i.e. virtual machines 122, 132 and 142). Servers 120, 130 and 140 host virtual machines 122, 132 and 142, which are monitored by resource planner 110. In exemplary embodiments, servers 120, 130 and 140 can be desktop computers, computer servers, or any other computer systems known in the art. In certain embodiments, servers 120, 130 and 140 represent computer systems utilizing clustered computers and components (e.g., database server computers, application server computers, etc.) that act as a single pool of seamless resources when accessed by elements of data processing environment 100 (i.e. resource planner 110). In general, servers 120, 130 and 140 are each representative of any electronic device or combination of electronic devices capable of executing machine-readable program instructions, as described in greater detail with regard to FIG. 5.

In exemplary embodiments, virtual machines 122, 132 and 142 each represent one or more virtual machines partitioned from respective servers 120, 130, and 140. Virtual machines 122, 132 and 142 are software implemented abstractions of hardware of servers 120, 130 and 140. Virtual machines 122, 132 and 142 can be utilized to emulate functions of a physical computer (e.g., execute programs). In another embodiment, virtual machines 122, 132 and 142 are representations of any forms of virtual devices implemented on servers 120, 130 and 140. In one embodiment, resources of servers 120, 130 and 140 (e.g., memory, central processing units (CPUs), storage devices, and I/O devices) can be partitioned into one or more virtual machines in virtual machines 122, 132 and 142. In another embodiment, allocation of resources of servers 120, 130 and 140 can be modified by resource planner 110 utilizing DLPAR. An exemplary depiction of server 120 including virtual machines 122 is depicted in example server 200 discussed in greater detail with regard to FIG. 2.

FIG. 2 is an exemplary depiction of example server 200 in accordance with an exemplary embodiment of the present invention. In one embodiment, example server 200 includes an exemplary depiction of server 120 from data processing environment 100, wherein server 120 includes virtual machines 210, 220 and 230 (which are included in virtual machines 122). A break up of virtual machine 230 depicts virtual machine resource usage 232, CPU utilization 234, memory utilization 235, I/O utilization 236, and resource limitation 238. Virtual machines 210 and 220 include respective instances of the elements of virtual machine 230. Virtual machine 210 includes virtual machine resource usage 212, CPU utilization 214, memory utilization 215, I/O utilization 216, and resource limitation 218. Virtual machine 220 includes virtual machine resource usage 222, CPU utilization 224, memory utilization 225, I/O utilization 226, and resource limitation 228.

In an exemplary embodiment, virtual machine resource usage 232 tracks the utilization of resources allocated to virtual machine 230. The resources allocated to virtual machine 230 are a subset of the resources of server 120. In an example, a hypervisor utilizes LPARs to allocate resources of server 120, and virtual machines 210, 220 and 230 are implemented on LPARs of server 120. Resource utilization information of virtual machines 210, 220 and 230 is sent to resource planner 110. In one embodiment, CPU utilization 234, memory utilization 235, and I/O utilization 236 is representative of the resources allocated to virtual machine 230 that are tracked by virtual machine resource usage 232. Resource limitation 238 is a resource utilization threshold associated with the resources allocated to virtual machine 230 that indicates when a resource is being over utilized. If a resource's utilization (i.e. CPU utilization 234, memory utilization 235, and I/O utilization 236) exceeds resource limitation 238, then virtual machine resource usage 232 tracks that the resource is over-utilized. In other embodiments, virtual machine resource usage 232 can track utilization of additional resources of virtual machine 230 (in addition to CPU utilization 234, memory utilization 235, and I/O utilization 236). CPU utilization 234 tracks the utilization of CPUs in server 120 that are allocated to virtual machine 230 over a given time period, and compared to resource limitation 238. Memory utilization 235 tracks the utilization of memory (i.e. random-access memory (RAM), flash memory, etc.) in server 120 that is allocated to virtual machine 230 over a given time period, and compared to resource limitation 238. I/O utilization 236 tracks the utilization of I/O devices (i.e. network interface cards (NICs) in server 120 that are allocated to virtual machine 230 over a given time period, and compared to resource limitation 238. In exemplary embodiments, the utilization tracked in CPU utilization 234, memory utilization 235, and I/O utilization 236 is dependent on workloads experienced by virtual machine 230, and is therefore different at different points in time (i.e. day, week, etc.). In another embodiment, when resources of server 120 are reallocated (i.e. through DLPAR) between virtual machines 210, 220 and 230, respective resource limitations 218, 228 and 238 are modified corresponding to the new resource allocation.

FIG. 3 is a flowchart depicting operational steps of resource management program 300 in accordance with an exemplary embodiment of the present invention. In one embodiment, resource management program 300 utilizes data stored on storage device 112, which has been gathered from virtual machines 122, 132 and 142 on servers 120, 130 and 140.

In step 302, resource management program 300 receives utilization information and workload information corresponding to one or more virtual machines. In one embodiment, resource management program 300 is constantly monitoring utilization of resources associated with virtual machines 122, 132 and 142, and storing the received data in storage device 112. The received utilization information includes an amount that each resource of a virtual machine is utilized (e.g., a percentage) at a given time compared to a limitation of the resource. For example, in virtual machine 230 (FIG. 2) virtual machine resource usage 232 includes resource limitation 238 for CPU utilization 234, memory utilization 235, and I/O utilization 236. In this example, relative to resource utilization 238, CPU utilization 234 indicates an over-utilization of CPUs allocated to virtual machine 230 during the given time. The received workload information includes the historical workloads (i.e. tasks processed by a virtual machine) experienced by a virtual machine during a given time period. For example, virtual machine 230 (FIG. 2) experiences varying workloads across a given time period corresponding to different types of tasks assigned to virtual machine 230. In this example, workloads may be allocated to virtual machine 230 in batches (e.g., billing processing), and responsive to a user interactive behavior (e.g., a web server).

In one embodiment, utilization information and workload information are associated with each other so that resource management program 300 is able to understand which workloads correlate to utilization spikes or resource over-utilization. For example, resource management program 300 can utilize the association between utilization information and workload information to identify which workload is associated with a resource over-utilization. In exemplary embodiments, a time period associated with workload information can be different (i.e. hour, day, week) based on different workload scenarios (i.e. workload batches, and user interactive behavior). In an example with regard to example server 200, resource management program 300 (on resource planner 110) receives utilization information and workload information corresponding to resources allocated to virtual machines 122, 132 and 142 from respective instances of virtual machine resource usage 212, 222 and 232. In one embodiment, resource management program 300 utilizes received utilization and workload information to compose a history corresponding to virtual machine usage (e.g., virtual machines 122, 132 and 142). In an exemplary embodiment, resource management program 300 receives utilization information and workload information for each virtual machine included in virtual machines 122, 132 and 142.

In step 304, resource management program 300 analyzes the received utilization information and workload information to determine a corresponding utilization profile and workload profile. In one embodiment, resource management program 300 utilizes historical utilization information and workload information (discussed in step 302) corresponding to a virtual machine (e.g., virtual machine 230 in FIG. 2) stored in storage device 112 to determine a corresponding utilization profile and workload profile for the virtual machine. Utilization and workload profiles are comprised of one or more instances of received historical utilization and workload information (from step 302) corresponding to a virtual machine. For example, resource management program 300 utilizes utilization and workload information corresponding to virtual machine 230 to determine a utilization profile and a workload profile that is a representation of the historical utilization and workload of virtual machine 230. In an exemplary embodiment, resource management program 300 determines a utilization profile and a workload profile for each virtual machine included in virtual machines 122, 132 and 142.

In step 306, resource management program 300 identifies candidate virtual machines for resource reallocation. In one embodiment, resource management program 300 identifies one or more virtual machines in virtual machines 122, 132 or 142 that have an associated history of over-utilization, and one or more virtual machine that have an associated history of under-utilization. Associated historical information corresponding with over-utilization or under-utilization is includes in the utilization and workload profiles stored in storage device 112. In exemplary embodiments, resource management program 300 considers a virtual machine to be over-utilized if one or more of the sets of resources (e.g., CPU, memory, I/O devices) allocated to the virtual machine has a historical pattern of over-utilization, and resource management program 300 considers a virtual machine to be under-utilized if one or more of the sets of resources (e.g., CPU, memory, I/O devices) allocated to the virtual machine has a historical pattern of under-utilization. A historical pattern of over-utilization or under-utilization can be when a virtual machine has an associated utilization and workload profile indicating a utilization history corresponding to a workload or time frame (e.g., a certain workload has historically lead to an over-utilization of a virtual machine's allocated memory).

For example with regard to FIG. 2, resource management program 300 identifies that memory allocated to virtual machine 220 has an associated history of over-utilization (memory utilization 225), and memory allocated to virtual machine 230 has an associated history of under-utilization (memory utilization 235). In this example, resource management program 300 identifies virtual machines 220 and 230 as candidate virtual machines for resource reallocation. Resource management program 300 identifies a resource as over-utilized if the utilization of the resource exceeds the limitation corresponding to the resource (i.e. memory utilization 225 exceeding resource limitation 228). If resource management program 300 cannot identify a virtual machine including an under-utilized resource, then the virtual machine including an over-utilized resource is not a candidate for reallocation. In another exemplary embodiment, resource management program 300 can identify more than one virtual machine with an associated history of over-utilization, or more than one virtual machine with an associated history of under-utilization as candidate virtual machines for resource reallocation. The resources of virtual machines 122, 132 and 142 that resource management program 300 identifies are non-shared virtual machine resources.

In step 308, resource management program 300 determines resources in the identified candidate virtual machines for reallocation. In one embodiment, resource management program 300 determines which resources in the identified candidate virtual machines are to be reallocated (from step 306). In exemplary embodiments, resource management program 300 determines one or more over-utilized resources in the identified over-utilized candidate virtual machine to be reallocated (from step 306) having a history of over-utilization. In one embodiment, to determine a history of over-utilization resource management program 300 utilizes a utilization profile and a workload profile (from step 304) stored in storage device 112 (comprised of received utilization and workload information from step 302) associated with the identified over-utilized candidate virtual machine. The utilization profile and the workload profile indicate utilization patterns associated with the over (and under) utilized resource(s) in the candidate virtual machine. If resource management program 300 determines that an over-utilized resource in the candidate virtual machine has a history of over-utilization, then the resource can be reallocated. In another embodiment, in step 306 resource management program 300 identifies a virtual machine including an under-utilized resource, wherein the under-utilized resource is the same resource type (e.g., CPU, memory, and I/O device) as the identified over-utilized resource.

In a previously discussed example with regard to FIG. 2, in step 306 resource management program 300 identifies that memory allocated to virtual machine 220 has an associated history of over-utilization (memory utilization 225), and memory allocated to virtual machine 230 has an associated history of under-utilization (memory utilization 235). In this example, resource management program 300 accesses the utilization and workload profiles associated with virtual machine 220 (in storage device 112) and determines that the utilization and workload profiles indicate that memory allocated to virtual machine 220 has a historical pattern of over-utilization. Since memory allocated to virtual machine 220 has a history of over-utilization and memory allocated to virtual machine 230 has a history of under-utilization that corresponds to the historical pattern of over-utilization of virtual machine 220, resource management program 300 determines the memory resources in the candidate virtual machines (virtual machines 220 and 230) for reallocation.

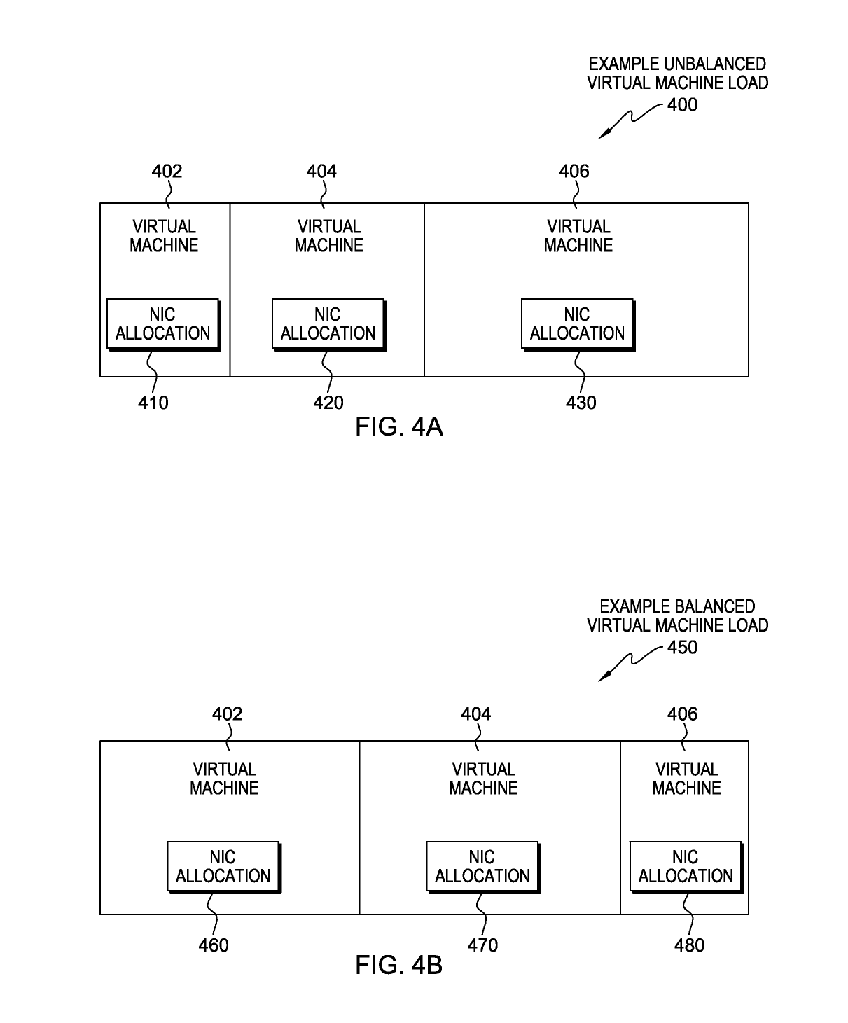

In another example, FIG. 4A depicts example unbalanced virtual machine load 400, wherein virtual machines 402, 404 and 406 have respective instances of Network Interface Card (NIC) allocations 410, 420 and 430. In this example, NIC allocation 410 includes two NICs, NIC allocation 420 includes three NICs, and NIC allocation 430 includes five NICs. Resource management program 300 identifies virtual machines 402 and 404 as having an associated history of over-utilization, and virtual machine 406 as having a corresponding history of under-utilization (in step 306). In step 308, resource management program 300 determines that the NICs (NIC allocations 410 and 420) in virtual machines 402 and 404 are resources with a history of over-utilization, and the NICs (NIC allocation 430) in virtual machine 406 are resources with a history of under-utilization that corresponds to the history of over-utilization of virtual machines 402 and 404. In this example, resource management program 300 determines NIC allocations 410, 420, and 430 in virtual machines 402, 404 and 406 for resource reallocation. In another exemplary embodiment, under-utilized resources of virtual machines can be shut down until the resources are required to accomplish a workload.

In step 310, resource management program 300 reallocates resources corresponding to the determined resources of the identified virtual machines. In one embodiment, resource management program 300 utilizes DLPAR to reallocate determined under-utilized resources of a virtual machine to a determined virtual machine with over-utilized resources (determined in step 308). In exemplary embodiments, resource management program 300 reallocates resources between virtual machines to reduce, or if possible eliminate over-utilization of resources. Resource management program 300 can utilize data in storage device 112 associated with workload information to determine an amount of resources to be reallocated. For example, resource management program 300 utilizes heuristic assumptions from utilization and workload information in storage device 112 indicating an impact that increasing a resource will have on utilization (e.g., that allocating another CPU to a virtual machine has a certain impact on utilization). In another embodiment, an administrator (i.e. an individual managing resource planner 110) has an option to determine whether determined resources (from step 308) are reallocated or not reallocated. In exemplary embodiments, resource management program 300 reallocates resources to achieve a balanced utilization or resources, wherein over-utilization of resources is minimized.

In the previously discussed example with regard to FIG. 4, in step 308 resource management program 300 determined that NIC allocations 410 and 420 of virtual machines 402 and 404 have an associated history of over-utilization, and NIC allocation 430 of virtual machine 406 has a corresponding history of under-utilization (in step 306). In this example, resource management program 300 reallocates NICs from virtual machine 406 to virtual machines 402 and 404. FIG. 4B depicts example balanced virtual machine load 450, wherein virtual machines 402, 404 and 406 have respective instances of Network Interface Card (NIC) allocations 460, 470 and 480. In this example, resource management program 300 reallocates NICs allocated to virtual machines 402, 404 and 406 (previously NIC allocations 410, 420 and 430 in FIG. 4A) to NIC allocations 460, 470 and 480. NIC allocation 460 includes four NICs, NIC allocation 470 includes four NICs, and NIC allocation 480 includes two NICs. After reallocation, virtual machines 402, 404 and 406 have an optimized utilization, wherein NIC allocations 460, 470 and 480 of virtual machines 412, 404 and 406 are not being over-utilized.

In another embodiment, an individual associated with resource planner 110 can utilize utilization and workload profiles in storage device 112 that are associated with virtual machines 122, 132 and 142 to determine points in time that a virtual machine will not have sufficient resources for a workload. The workload profile can include an indication of a time of day that certain workloads cause virtual machines 122, 132 or 142 to be over-utilized, so an individual associated with resource planner (i.e. a system administrator) optimize the distribution of the workloads in order to avoid over-utilization of virtual machine resources. In another embodiment, resource management program 300 can adjust a workload schedule in order to reduce virtual machine resource over-utilization. In exemplary embodiments, resource management program 300 operates while virtual machines 122, 132 and 142 are operating, constantly receiving utilization and workload information, and identifying virtual machine resource over-utilization.

FIG. 4A is an exemplary depiction of example unbalanced virtual machine load 400 in accordance with an exemplary embodiment of the present invention. Example unbalanced virtual machine load 400 includes virtual machines 402, 404 and 406 that have respective instances of NIC allocations 410, 420 and 430. In exemplary embodiments, NIC allocation 410 includes two NICs, NIC allocation 420 includes three NICs, and NIC allocation 430 includes five NICs. Example unbalanced virtual machine load 400 is discussed in greater detail with regard to FIG. 3.

FIG. 4B is an exemplary depiction of example balanced virtual machine load 450 in accordance with an exemplary embodiment of the present invention. Example balanced virtual machine load 450 includes virtual machines 402, 404 and 406 that have respective instances of NIC allocations 460, 470 and 480. In exemplary embodiments, NIC allocation 460 includes four NICs, NIC allocation 470 includes four NICs, and NIC allocation 480 includes two NICs. Example balanced virtual machine load 450 is discussed in greater detail with regard to FIG. 3.

FIG. 5 depicts a block diagram of components of computer 500, which is representative of resource planner 110, and servers 120, 130 and 140 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computer 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media. Software and data 522 stored in persistent storage 508 for access and/or execution by processors 504 via one or more memories of memory 506. With respect to resource planner 110, software and data represents resource management program 300. With respect to servers 120, 130 and 140, software and data 522 represents virtual machines 122, 132 and 142 respectively.

In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Software and data 522 may be downloaded to persistent storage 508 through communications unit 510.

I/O interface(s) 512 allows for input and output of data with other devices that may be connected to computer 500. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data 522 can be stored on such portable computer-readable storage media and can be loaded onto persistent storage 508 via I/O interface(s) 512. I/O interface(s) 512 also can connect to a display 520.

Display 520 provides a mechanism to display data to a user and may be, for example, a computer monitor. Display 520 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for resource management for virtual machines, the method comprising:
a computer receiving information associated with one or more virtual machines, wherein the received information includes utilization information and workload information associated with each virtual machine of the one or more virtual machines;
the computer analyzing the received information associated with the one or more virtual machines; and
the computer determining virtual machines for resource reallocation, wherein the determined virtual machines include at least one or more over-utilized virtual machines including at least one over-utilized resource.

2. The method of claim 1, further comprising:
the computer reallocating resources of the determined virtual machines for resource reallocation.

3. The method of claim 1, wherein analyzing the received information associated with the one or more virtual machines, comprises:
the computer determining a utilization profile and a workload profile associated with each respective virtual machine of the one or more virtual machines utilizing received utilization information and workload information,
wherein the utilization profile is comprised of utilization information indicating utilization of one or more resources of a virtual machine compared to a limitation of each of the one or more resources,
wherein the workload profile is comprised of workload information indicating a schedule of workloads that a virtual machine has experienced.

4. The method of claim 1, wherein determining virtual machines for resource reallocation, comprises:
the computer identifying one or more over-utilized virtual machines utilizing analyzed received information, wherein the identified one or more over-utilized virtual machines have a history of over-utilization;
the computer determining one or more over-utilized resources of the identified one or more over-utilized virtual machines; and
the computer determining one or more under-utilized virtual machines, wherein the one or more under-utilized virtual machines include at least one under-utilized resource that corresponds to the determined one or more over-utilized resources of the identified one or more over-utilized virtual machines.

5. The method of claim 2, wherein reallocating resources of the determined virtual machines for resource reallocation, comprises:
the computer reallocating resources of one or more under-utilized virtual machines to one or more over-utilized virtual machines.

6. The method of claim 1, wherein resources of a virtual machine are non-shared resources that are allocated to the virtual machine.

7. The method of claim 1, further comprising:
the computer proposing a change in workload for the one or more determined over-utilized virtual machines.

8. A computer program product for resource management for virtual machines, the computer program product comprising:
one or more computer-readable storage media and program instructions stored on the one or more computer-readable storage media, the program instructions comprising:
program instructions to receive information associated with one or more virtual machines, wherein the received information includes utilization information and workload information associated with each virtual machine of the one or more virtual machines;
program instructions to analyze the received information associated with the one or more virtual machines; and
program instructions to determine virtual machines for resource reallocation, wherein the determined virtual machines include at least one or more over-utilized virtual machines including at least one over-utilized resource.

9. The computer program product of claim 8, further comprising program instructions to:
reallocate resources of the determined virtual machines for resource reallocation.

10. The computer program product of claim 8, wherein program instructions to analyze the received information associated with the one or more virtual machines, comprise program instructions to:
determine a utilization profile and a workload profile associated with each respective virtual machine of the one or more virtual machines utilizing received utilization information and workload information,
wherein the utilization profile is comprised of utilization information indicating utilization of one or more resources of a virtual machine compared to a limitation of each of the one or more resources,
wherein the workload profile is comprised of workload information indicating a schedule of workloads that a virtual machine has experienced.

11. The computer program product of claim 8, wherein program instructions to determine virtual machines for resource reallocation, comprise program instructions to:
identify one or more over-utilized virtual machines utilizing analyzed received information, wherein the identified one or more over-utilized virtual machines have a history of over-utilization;
determine one or more over-utilized resources of the identified one or more over-utilized virtual machines; and
determine one or more under-utilized virtual machines, wherein the one or more under-utilized virtual machines include at least one under-utilized resource that corresponds to the determined one or more over-utilized resources of the identified one or more over-utilized virtual machines.

12. The computer program product of claim 9, wherein program instructions to reallocate resources of the determined virtual machines for resource reallocation, comprise program instructions to:
reallocate resources of one or more under-utilized virtual machines to one or more over-utilized virtual machines.

13. The computer program product of claim 8, wherein resources of a virtual machine are non-shared resources that are allocated to the virtual machine.

14. The computer program product of claim 8, further comprising program instructions to:
propose a change in workload for the one or more determined over-utilized virtual machines.

15. A computer system for resource management for virtual machines, the computer system comprising:
one or more computer processors; and
one or more computer-readable storage media;
program instructions stored on the computer-readable storage media for execution by at least one of the one or more processors, the program instructions comprising:
program instructions to receive information associated with one or more virtual machines, wherein the received information includes utilization information and workload information associated with each virtual machine of the one or more virtual machines;
program instructions to analyze the received information associated with the one or more virtual machines; and
program instructions to determine virtual machines for resource reallocation, wherein the determined virtual machines include at least one or more over-utilized virtual machines including at least one over-utilized resource.

16. The computer system of claim 15, further comprising program instructions to:
reallocate resources of the determined virtual machines for resource reallocation.

17. The computer system of claim 15, wherein program instructions to analyze the received information associated with the one or more virtual machines, comprise program instructions to:
determine a utilization profile and a workload profile associated with each respective virtual machine of the one or more virtual machines utilizing received utilization information and workload information,
wherein the utilization profile is comprised of utilization information indicating utilization of one or more resources of a virtual machine compared to a limitation of each of the one or more resources,
wherein the workload profile is comprised of workload information indicating a schedule of workloads that a virtual machine has experienced.

18. The computer system of claim 15, wherein program instructions to determine virtual machines for resource reallocation, comprise program instructions to:
identify one or more over-utilized virtual machines utilizing analyzed received information, wherein the identified one or more over-utilized virtual machines have a history of over-utilization;
determine one or more over-utilized resources of the identified one or more over-utilized virtual machines; and
determine one or more under-utilized virtual machines, wherein the one or more under-utilized virtual machines include at least one under-utilized resource that corresponds to the determined one or more over-utilized resources of the identified one or more over-utilized virtual machines.

19. The computer system of claim 16, wherein program instructions to reallocate resources of the determined virtual machines for resource reallocation, comprise program instructions to:
reallocate resources of one or more under-utilized virtual machines to one or more over-utilized virtual machines.

20. The computer system of claim 15, further comprising program instructions to:
propose a change in workload for the one or more determined over-utilized virtual machines.
